(19) United States
(12) Patent Application Publication
(10) Pub. No.: US 2020/0177669 A1
(43) Pub. Date: Jun. 4, 2020

(54) INFORMATION PROCESSING DEVICE, CHARGEABLE CABINET AND NON-TRANSITORY COMPUTER READABLE MEDIUM

(71) Applicant: FUJITSU CLIENT COMPUTING LIMITED, Kanagawa (JP)

(72) Inventors: Hiroyuki Maekawa, Kawasaki (JP); Kouichi Matsuda, Kawasaki (JP); Kazuhiro Takeda, Kawasaki (JP); Yuki Yai, Kawasaki (JP); Tsuyoshi Sakamaki, Kawasaki (JP)

(73) Assignee: FUJITSU CLIENT COMPUTING LIMITED, Kanagawa (JP)

(21) Appl. No.: 16/653,296

(22) Filed: Oct. 15, 2019

(30) Foreign Application Priority Data
Nov. 30, 2018 (JP) 2018-225932

(51) Int. Cl. H04L 29/08; H02J 7/00

(52) U.S. Cl. CPC H04L 67/06; H02J 7/0047; H04L 67/10; H02J 7/0044; H04L 67/025; H02J 7/0021

(57) ABSTRACT

According to one aspect of the present disclosure, an information processing device includes a selector, a controller, and a communicator. The selector selects a plurality of first information terminals to be used for first material data from among a plurality of information terminals each having a display screen and an indicator light. The controller generates first flashing control information to flash the indicator lights of the first information terminals in a first flashing pattern. The communicator transmits the first material data and the first flashing control information to each of the selected first information terminals.

### CROSS-REFERENCE TO RELATED APPLICATIONS

This application is a based upon and claims the benefit of priority from Japanese Patent Application No. 2018-225932 filed on Nov. 30, 2018, the entire contents of which are incorporated herein by reference.

### TECHNICAL FIELD

Embodiments described herein relate generally to an information processing device, a chargeable cabinet, and a non-transitory computer readable medium.

### BACKGROUND

Information terminals such as electronic paper provide display with memory characteristics and are lightweight and thin, which facilitate carrying and distribution of electronic paper. Such information terminals are sometimes used in a meeting in such a manner that the information terminals are stored in a chargeable cabinet in advance, and users use the information terminals as an alternative to paper materials by taking out the information terminals from the chargeable cabinet.

### SUMMARY

The required number of information terminals (electronic paper) varies for each meeting. When only some of information terminals in the chargeable cabinet are to be used, distribution of material data to all the information terminals in the chargeable cabinet before the meeting causes waste of unused information terminals in the chargeable cabinet.

According to one aspect of the present disclosure, an information processing device includes a selector, a controller, and a communicator. The selector is configured to select a plurality of first information terminals to be used for first material data from among a plurality of information terminals each having a display screen and an indicator light. The controller is configured to generate first flashing control information to flash the indicator lights of the first information terminals in a first flashing pattern. The communicator is configured to transmit the first material data and the first flashing control information to each of the selected first information terminals.

### BRIEF DESCRIPTION OF THE DRAWINGS

FIG. 1 is a diagram showing a paperless meeting system including an information processing device according to an embodiment;

FIG. 2 is a diagram showing an external configuration of a chargeable cabinet in the embodiment;

FIG. 3 is a diagram showing the storage state of the information processing device (electronic paper) in the embodiment;

FIG. 4 is a diagram showing a hardware configuration of the information processing device according to the embodiment;

FIG. 5 is a flowchart showing a meeting preparation process in the embodiment;

FIGS. 6A and 6B are diagrams each showing a data structure of information used in the meeting preparation process in the embodiment;

FIG. 7 is a flowchart showing a meeting conduct process in the embodiment;

FIG. 8 is a diagram showing a data structure of information used in the meeting conduct process in the embodiment;

FIGS. 9A and 9B are diagrams each showing a flashing operation of an information terminal (electronic paper) in the embodiment;

FIG. 10 is a diagram showing a circuit configuration of a display control circuit in the embodiment;

FIG. 11 is a diagram showing the operation of the display control circuit in the embodiment;

FIG. 12 is a diagram showing a flashing operation of the chargeable cabinet in the embodiment;

FIG. 13 is a flowchart showing a meeting termination process in the embodiment; and

FIGS. 14A to 14C are diagrams each showing a data structure of information used in the meeting termination process in the embodiment.

### DETAILED DESCRIPTION

Embodiments of an information processing device disclosed by the subject application will be described in detail below with reference to the drawings. It should be noted that the disclosed technique is not limited by the embodiments. The configuration having the same function in embodiments is denoted by the same reference sign and an overlapping description will be omitted.

### Embodiments

An information processing device according to an embodiment is used to manage information terminals in a paperless meeting system. In the paperless meeting system, a meeting is carried out while a material used in the meeting is displayed on an information terminal (electronic paper). This paperless meeting system eliminates the need for distributing paper materials to participants and thus can reduce costs.

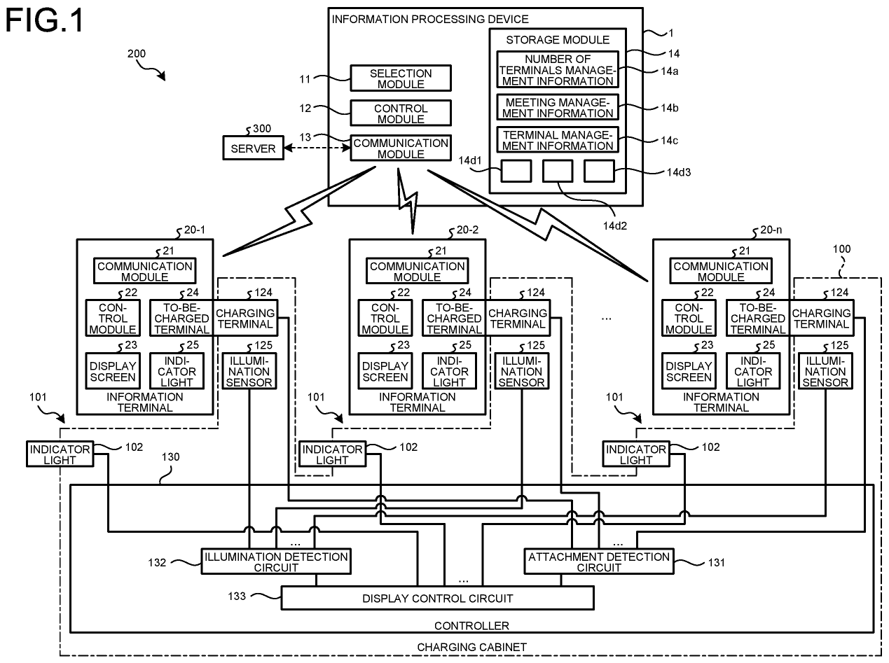

For example, a paperless meeting system 200 is configured as illustrated in FIG. 1. FIG. 1 is a diagram showing the paperless meeting system 200 including an information processing device 1.

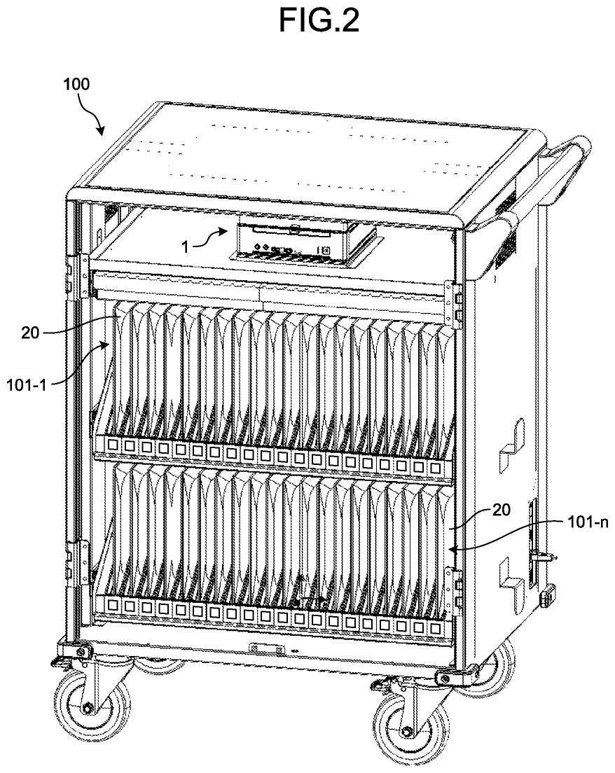

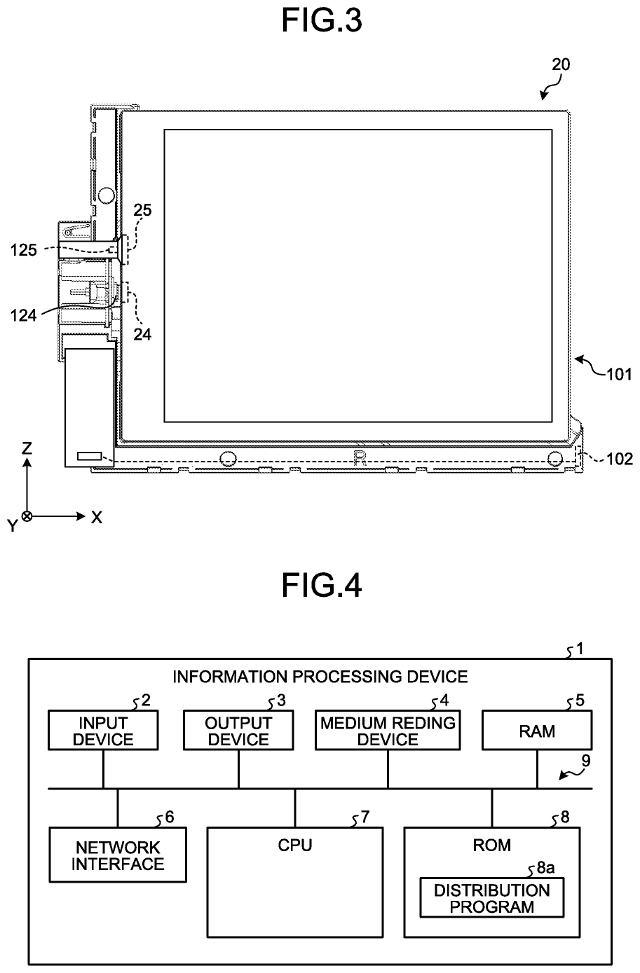

The paperless meeting system 200 includes the information processing device 1, a plurality of information terminals 20-1 to 20-n, and a chargeable cabinet 100. The information processing device 1 can be connected to a plurality of information terminals 20-1 to 20-n to communicate through a wireless communication link (for example, wireless LAN). The information processing device 1 can manage a communication state with the information terminals 20-1 to 20-n through the wireless communication link and can grasp an information terminal capable of wireless communication and an information terminal incapable of wireless communication of the information terminals 20-1 to 20-n. The information processing device 1 is, for example, an edge computer and performs management of meeting material data and the information terminals (electronic paper) as well as data communication. The information terminal 20 may be used by a meeting participant to view and write down in the material. In the chargeable cabinet 100, a predetermined number, n (for example, n=40) information terminals 20-1 to 20-n are stored. As illustrated in FIG. 2, the chargeable cabinet 100 has a plurality of housing spaces (a plurality of racks) 101-1 to 101-n. The information terminals 20 are stored side by side in the racks 101. FIG. 2 is a diagram illustrating an external configuration of the chargeable cabinet 100. The chargeable cabinet 100 manages charging of the stored information terminals 20-1 to 20-n. In storage, as illustrated in FIG. 3, the to-be-charged terminal (to-be-charged connector) of the information terminal 20 is connected to a charging terminal (feeding connector) in the rack 101 for charging. FIG. 3 is a diagram showing the storage state of the information terminal 20. The stored information terminals 20-1 to 20-n thus can be charged in the chargeable cabinet 100.

The required number of information terminals 20 varies for each meeting. When only some of the information terminals 20 in the chargeable cabinet 100 are to be used, distribution of material data to all the information terminals 20-1 to 20-n in the chargeable cabinet 100 before a meeting causes waste of unused information terminals 20 in the chargeable cabinet 100. For example, when a meeting with ten participants is conducted in a situation in which forty information terminals 20 are stored in the chargeable cabinet 100, thirty information terminals 20 may be unused and become unnecessary. Sending material data to the unused information terminals 20 may cause performance loss, for example, a longer time required for distribution from the information processing device 1 to the information terminals 20.

Since the users can store the information terminals 20 into any housing spaces 101 in the chargeable cabinet 100, it is difficult to grasp in which housing space 101 each information terminal 20 is stored. When material data is sent to the required number of information terminals 20, the waste of information terminals and performance loss can be prevented, but it may be difficult for the meeting participants to identify which information terminal in the chargeable cabinet 100 to use.

In view of the above, in the paperless meeting system 200 in the present embodiment, the information processing device 1 selectively transmits material data and flashing control information to the required number of information terminals in the chargeable cabinet 100 to flash the indicator lights of the required number of information terminals and also flash the indicator lights of the housing spaces accordingly, thereby enabling the meeting participants to easily identify which information terminal in the chargeable cabinet 100 to use.

Specifically, “who”, “in which meeting”, and “which electronic paper to use” are managed by software. When a meeting is conducted, the indicator lights (status LED) of applicable information terminals are flashed. The information processing device 1 can distribute and retrieve meeting material data to/from the information terminals used in the meeting. The management of meeting material and the allocation of information terminals to be used in a meeting are managed by the information processing device 1. This enables allocation of the required number of information terminals per meeting and makes the remaining information terminals available to another meeting. Target information terminals can be identified even when they are stored in the chargeable cabinet 100, without a modification to the information terminals themselves.

More specifically, the hardware of the information processing device 1 may be configured as illustrated in FIG. 4. The information processing device 1 executes a distribution program 8a. The information processing device 1 has an input device 2 such as a keyboard and a touch panel to receive data and a variety of settings from a user and an output device 3 such as a display device to notify the user of a state of the computer. The information processing device 1 further includes a network interface 6 to exchange data with another device, a medium reading device 4, a random access memory (RAM) 5, a read only memory (ROM) 8, a central processing unit (CPU) 7, and a bus 9. Each of the elements 2 to 8 is connected to the bus 9. The distribution program 8a is stored in advance in the ROM 8. The CPU 7 reads and executes the distribution program 8a from the ROM 8 to develop the functional configuration as illustrated in FIG. 1 on the RAM 5 collectively during compiling or sequentially with the progress of processing.

Specifically, the information processing device 1 may be functionally configured as illustrated in FIG. 1. The information processing device 1 includes a selector 11, a controller 12, a communicator 13, and a storage 14. The storage 14 stores number of terminals management information 14a, meeting management information 14b, and terminal management information 14c. The communicator 13 is connected to communicate with a server 300 through a wired communication link (for example, network) and is connected to communicate with a plurality of information terminals 20-1 to 20-n through a wireless communication link (for example, wireless LAN). Each information terminal 20 has a communicator 21, a controller 22, a display screen 23, a to-be-charged terminal 24, and an indicator light 25. The storage 14 can store a plurality of meeting material data 14d1 to 14d3 for different meetings.

The selector 11 selects a plurality of information terminals (hereinafter denoted as a plurality of information terminals 20_14d1) to be used for meeting material data (first material data) 14d1 from among a plurality of information terminals 20-1 to 20-n. The selector 11 supplies the selection result to the controller 22 and to the communicator 13. The controller 22 generates first flashing control information to flash the indicator lights 25 of the information terminals 20_14d1 in a first flashing pattern, in accordance with the selection result of the selector 11. The controller 22 supplies the first flashing control information to the communicator 13. The communicator 13 reads the meeting material data 14d1 from the storage 14 and transmits the meeting material data 14d1 and the first flashing control information to each of the information terminals 20_14d1 selected by the selector 11. In each information terminal 20_14d1, the communicator 21 receives and supplies the meeting material data 14d1 and the first flashing control information to the controller 22. The controller 22 flashes the indicator light 25 in the first flashing pattern in accordance with the first flashing control information.

The selector 11 selects a plurality of information terminals (hereinafter denoted as a plurality of information terminals 20_14d2) to be used for meeting material data (second material data) 14d2 from among a plurality of information terminals 20-1 to 20-n. The selector 11 supplies the selection result to the controller 22 and to the communicator 13. The controller 22 generates second flashing control information to flash the indicator lights 25 of the information terminals 20_14d2 in a second flashing pattern, in accordance with the selection result of the selector 11. The controller 22 supplies the second flashing control information to the communicator 13. The communicator 13 reads the meeting material data 14d2 from the storage 14 and transmits the meeting material data 14d2 and the second flashing control information to each of the information terminals 20_14d2 selected by the selector 11. In each information terminal 20_14d2, the communicator 21 receives and supplies the meeting material data 14d2 and the second flashing control information to the controller 22. The controller 22 flashes the indicator lights 25 in the second flashing pattern in accordance with the second flashing control information.

The selector 11 selects a plurality of information terminals (hereinafter denoted as a plurality of information terminals 20_14d3) to be used for meeting material data (third material data) 14d3 from among a plurality of information terminals 20-1 to 20-n. The selector 11 supplies the selection result to the controller 22 and the communicator 13. The controller 22 generates third flashing control information to flash the indicator lights 25 of the information terminals 20_14d3 in a third flashing pattern, in accordance with the selection result of the selector 11. The controller 22 supplies the third flashing control information to the communicator 13. The communicator 13 reads the meeting material data 14d3 from the storage 14 and transmits the meeting material data 14d3 and the third flashing control information to each of the information terminals 20_14d3 selected by the selector 11. In each information terminal 20_14d3, the communicator 21 receives and supplies the meeting material data 14d3 and the third flashing control information to the controller 22. The controller 22 flashes the indicator light 25 in the third flashing pattern in accordance with the third flashing control information.

A plurality of information terminals 20-1 to 20-n thus display the indicator lights 25 in a flashing pattern different for each meeting, so that the users can easily identify and grasp in which meeting the information terminals 20 are used.

The chargeable cabinet 100 has a plurality of housing spaces 101, a plurality of indicator lights 102, and a controller 130.

A plurality of housing spaces 101 can store a plurality of information terminals 20. The users can store the information terminals 20 in any housing spaces 101 in the chargeable cabinet 100. However, the indicator lights 25 of the stored information terminals 20 are located on the back of the housing spaces 101 and are less visible from the outside of the chargeable cabinet 100. It is therefore difficult to grasp in which housing space 101 the information terminal 20 to be used in a meeting is stored.

A charging terminal 124 and an illumination sensor 125 are disposed in each housing space 101. The charging terminal 124 has a terminal shape corresponding to the to-be-charged terminal 24 of the information terminal 20.

A plurality of indicator lights 102 corresponds to a plurality of housing spaces 101. Each indicator light 102 is disposed at the front end of the corresponding housing space 101 (see FIG. 3).

The controller 130 controls lighting of a plurality of indicator lights 102, in accordance with the electrical continuity state of the charging terminals 124 in a plurality of housing spaces 101 and the detection result of the illumination sensors 125. For each of a plurality of housing spaces 101, the controller 130 controls lighting of the indicator light 102 in a display state corresponding to the display state of the indicator light 25, in accordance with the detection result of the illumination sensor 125. The controller 130 has an attachment detection circuit 131, an illumination detection circuit 132, and a display control circuit 133.

When the information terminal 20 is stored in the housing space 101, the charging terminal 124 can be electrically connected to the to-be-charged terminal 24, for example, through a magnet. The controller 130 then starts charging of the information terminal 20. At this moment, the attachment detection circuit 131 detects that the charging terminal 124 is attached to the to-be-charged terminal 24, in response to the charging terminal 124 being electrically connected, and provides the detection result to the display control circuit 133. The display control circuit 133 enables display of the indicator light 102, in response to the charging terminal 124 being electrically connected, that is, the charging terminal 124 being attached to the to-be-charged terminal 24. The illumination detection circuit 132 detects the display state of the indicator light 25.

For example, when the indicator light 25 flashes in the first flashing pattern, the illumination detection circuit 132 detects the first flashing pattern and provides the detection result to the display control circuit 133. When the indicator light 102 is enabled to display, the display control circuit 133 flashes the indicator light 102 in a flashing pattern corresponding to the first flashing pattern, in accordance with the detection result of the first flashing pattern.

For example, when the indicator light 25 flashes in the second flashing pattern, the illumination detection circuit 132 detects the second flashing pattern and provides the detection result to the display control circuit 133. When the indicator light 102 is enabled to display, the display control circuit 133 flashes the indicator light 102 in a flashing pattern corresponding to the second flashing pattern, in accordance with the detection result of the second flashing pattern.

For example, when the indicator light 25 flashes in the third flashing pattern, the illumination detection circuit 132 detects the third flashing pattern and provides the detection result to the display control circuit 133. When the indicator light 102 is enabled to display, the display control circuit 133 flashes the indicator light 102 in a flashing pattern corresponding to the third flashing pattern, in accordance with the detection result of the third flashing pattern.

With this configuration, a plurality of indicator lights 102 in the chargeable cabinet 100 display flashing patterns different for each meeting. As a result, when the flashing state of the indicator light 25 of each information terminal 20 housed in the housing space 101 is not visible (see FIG. 3), it can be easily identified and grasped in which meeting each information terminal 20 is to be used, from the outside of the chargeable cabinet 100. With this configuration, when a meeting is conducted, the users can easily grasp the information terminals 20 for the meeting they participate in, among a plurality of information terminals 20 stored in a plurality of housing spaces 101.

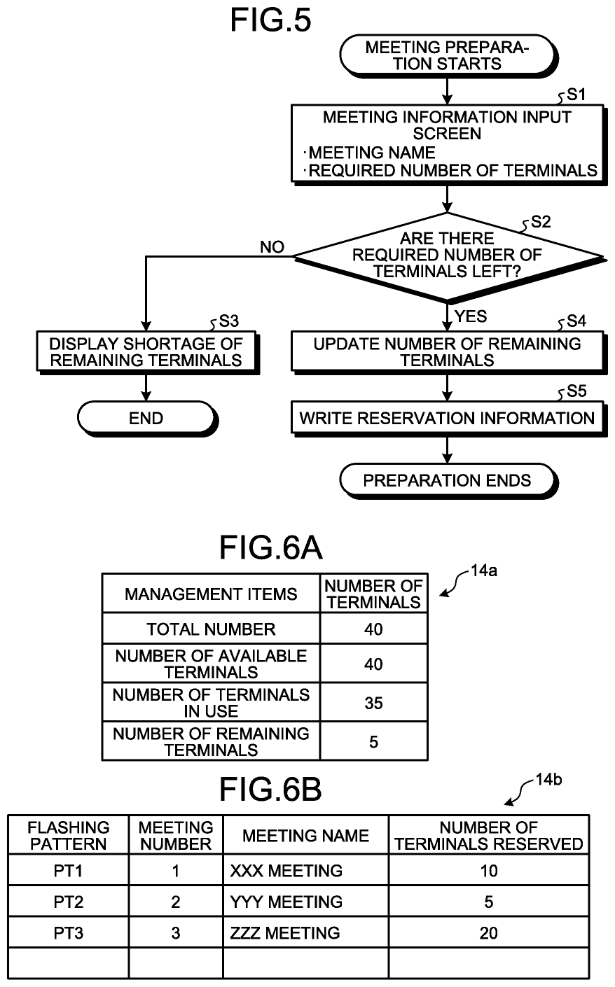

A meeting preparation process will now be described with reference to FIG. 5. FIG. 5 is a flowchart showing a meeting preparation process.

At the timing to prepare for a meeting before conducting the meeting (for example, two or three days before the meeting), the meeting organizer's terminal (not illustrated) accesses the server 300 to activate the paperless meeting system 200 on the server 300. Once the paperless meeting system 200 is activated, the meeting organizer's terminal displays a meeting information input screen for the paperless meeting system 200 on the display (S1). When meeting information (the meeting name, the required number of terminals) is input to the meeting organizer's terminal, the server 300 asks the information management device 1 to acquire the number of terminals management information 14a and determines whether the required number of terminals are left in the chargeable cabinet 100, in accordance with the paperless meeting system 200 (S2).

For example, the number of terminals management information 14a has a data structure as illustrated in FIG. 6A. FIG. 6A is a diagram illustrating the data structure of information used in the meeting preparation process. FIG. 6A illustrates the data structure of the number of terminals management information 14a. Referring to the number of terminals management information 14a, the total number of information terminals 20 housed in the chargeable cabinet 100 can be grasped by “total number”, the number of available terminals in an allowable communication state can be grasped by “number of available terminals”, the number of terminals reserved and already used in another meeting can be grasped by “number of terminals in use”, and the number of remaining terminals not in use can be grasped by “number of remaining terminals”.

For example, in preparation of a meeting with ten participants, when “10” is input to the meeting organizer's terminal as “required number”, the server 300 refers to the number of terminals management information 14a in accordance with the paperless meeting system 200. If in the number of terminals management information 14a, “total number” is “40”, “number of available terminals” is “40”, “number of terminals in use” is “35”, and “number of remaining terminals” is “5”, then “number of remaining terminals” is less than “required number”, and then the server 300 determines that the required number of terminals are not left (No at S2) and displays a message on the meeting organizer's terminal to indicate that the number of remaining information terminals 20 falls short of the required number (S3). The meeting preparation process is terminated as an error.

Alternatively, for example, in preparation of a meeting with ten participants, when “10” is input to the meeting organizer's terminal as “required number”, the server 300 updates the number of remaining information terminals. More specifically, the server 300 refers to the number of terminals management information 14a in accordance with the paperless meeting system 200. If in the number of terminals management information 14a, “total number” is “40”, “number of available terminals” is “40”, “number of terminals in use” is “25”, and “number of remaining terminals” is “15”, then “number of remaining terminals” is greater than “required number”, and the server 300 determines that the required number of terminals are left (Yes at S2) and updates the number of remaining information terminals in the number of terminals management information 14a (S4). More specifically, the server 300 updates “number of terminals in use” from “25” to “35” and updates “number of remaining terminals” from “15” to “5” in the number of terminals management information 14a and transfers the updated number of terminals management information 14a to the information management device 1. The information management device 1, receiving the updated number of terminals management information 14a, overwrites the number of terminals management information 14a on the storage 14.

When the number of terminals management information 14a is updated, the server 300 displays a reservation information input screen on the meeting organizer's terminal, in accordance with the paperless meeting system 200. When meeting material data is input to the meeting organizer's terminal, the server 300 asks the information management device 1 to acquire the meeting management information 14b and additionally writes information of the selected meeting as reservation information into the meeting management information 14b, in accordance with the paperless meeting system 200 (S5).

For example, the meeting management information 14b has a data structure as illustrated in FIG. 6B. FIG. 6B illustrates the data structure of the meeting management information 14b. Referring to the meeting management information 14b, “flashing pattern”, “meeting name”, and “number of terminals reserved” can be grasped for each “meeting number”. In the case in FIG. 6B, for a meeting number “1”, a flashing pattern PT1, a meeting name “XXX meeting”, and the number of terminals reserved 10 can be additionally written in the meeting management information 14b. The meeting management information 14b includes information of other meetings already reserved. For a meeting number “2”, a flashing pattern PT2, a meeting name “YYY meeting”, and the number of terminals reserved 5 can be grasped. For a meeting number “3”, a flashing pattern PT3, a meeting name “ZZZ meeting”, and the number of terminals reserved 20 can be grasped.

When the meeting management information 14b is updated, the server 300 transfers the updated meeting management information 14b to the information management device 1. The information management device 1, receiving the updated meeting management information 14b, overwrites the meeting management information 14b on the storage 14.

When a meeting participant stores meeting material data into the server 300, the server 300 transfers the meeting material data to the information processing device 1. When the meeting material data 14d1 corresponding to the meeting number “1” is received, the information management device 1 stores the meeting material data 14d1 into the storage 14 in association with the meeting number “1”. When the communicator 13 receives the meeting material data 14d2 corresponding to the meeting number “2”, the storage 14 stores the meeting material data 14d2 received from the communicator 13, in association with the meeting number “2”. When the communicator 13 receives the meeting material data 14d3 corresponding to the meeting number “3”, the storage 14 stores the meeting material data 14d3 received from the communicator 13, in association with the meeting number “3”.

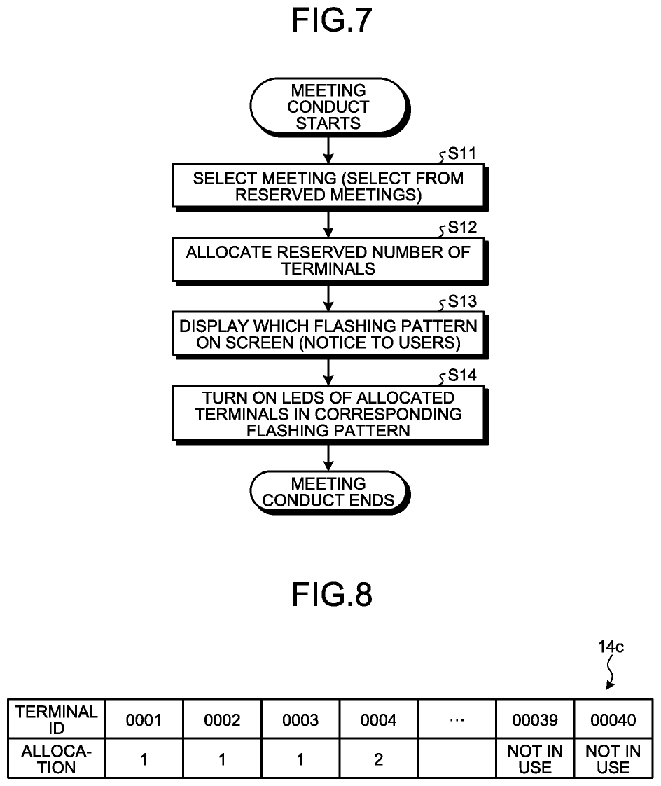

A meeting conduct process will now be described with reference to FIG. 7. FIG. 7 is a flowchart showing a meeting conduct process.

At the timing to conduct a meeting (for example, two to three hours before the meeting), the meeting organizer's terminal (not illustrated) accesses the server 300 to activate the paperless meeting system 200 on the server 300. Once the paperless meeting system 200 is activated, the meeting organizer's terminal displays a meeting select screen of the paperless meeting system 200 on the display and allows the user to select the corresponding meeting from the reserved meetings (S11). More specifically, the server 300 asks the information management device 1 to acquire the meeting management information 14b and displays a meeting list corresponding to the meeting management information 14b in the meeting select screen, in accordance with the paperless meeting system 200. When an instruction to select the meeting reserved at S5 is input to the meeting organizer's terminal, the server 300 allocates the reserved number of information terminals 20 as information terminals for the meeting (S12). More specifically, in response to the instruction to select the meeting, the server 300 asks the information management device 1 to acquire the terminal management information 14c, in accordance with the paperless meeting system 200. The server 300 overwrites the allocation state of the reserved number of information terminals, of the information terminals 20 with the allocation state “not in use” in the terminal management information 14c, with the meeting number.

For example, when the meeting with the meeting number “1” illustrated in FIG. 6B is selected, the number of terminals reserved is “10” and the state of allocation for ten terminals is updated from “not in use” to “1” in the terminal management information 14c illustrated in FIG. 8. In FIG. 8, for example, the allocation state of information terminals 20 with terminals IDs “0001”, “0002”, and “0003” is updated from “not in use” to “1”. The server 300 transfers the updated terminal management information 14c to the information management device 1. The information management device 1, receiving the updated terminal management information 14c, overwrites the terminal management information 14c on the storage 14.

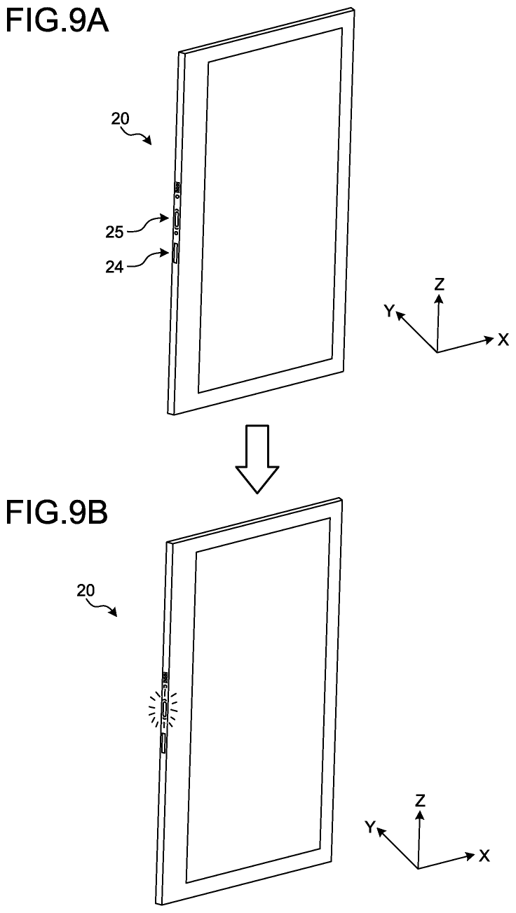

When the terminal management information 14c is updated, the server 300 displays a flashing pattern notice screen for the selected meeting (for example, the meeting with the meeting number “1”) on the meeting organizer's terminal and notifies the user which flashing pattern is associated with the selected meeting, in accordance with the paperless meeting system 200 (S13). When a response to acknowledge the flashing pattern is input to the meeting organizer's terminal, the server 300 transmits a permission to distribute meeting material data of the selected meeting to the information management device 1. The information management device 1, receiving the permission to distribute meeting material data of the selected meeting, refers to the meeting management information 14b and specifies the flashing pattern for the selected meeting. The information management device 1 generates flashing control information for the specified flashing pattern. The information management device 1 also refers to the terminal management information 14c and selects the information terminal 20 for the selected meeting from among a plurality of information terminals. The information management device 1 transmits the flashing control information to the selected information terminal 20. The information management device 1 then flashes the indicator light (LED) 25 of the allocated information terminal 20 in the corresponding flashing pattern (S14). For example, the indicator light 25 of the allocated information terminal 20 changes from the state illustrated in FIG. 9A to the state illustrated in FIG. 9B. FIG. 9A and FIG. 9B are diagrams illustrating the flashing operation of the information terminal 20.

In response, the indicator light (LED) at the front end of the housing space 101 of the corresponding information terminal 20 in the chargeable cabinet 100 flashes in the flashing pattern for the meeting. More specifically, as illustrated in FIG. 3, in the information terminal 20 and the chargeable cabinet 100, a charge port, a power switch, and a status LED are often disposed on the same plane, for the structural reason and for feedback of the operation. In such a case, if the information terminal 20 is constructed to be charged only by insertion into the housing space 101 of the chargeable cabinet 100, the status LED faces the back and is hidden. The indicator light (LED) 102 that detects light of the status LED and is separately installed in the chargeable cabinet 100 is therefore flashed.

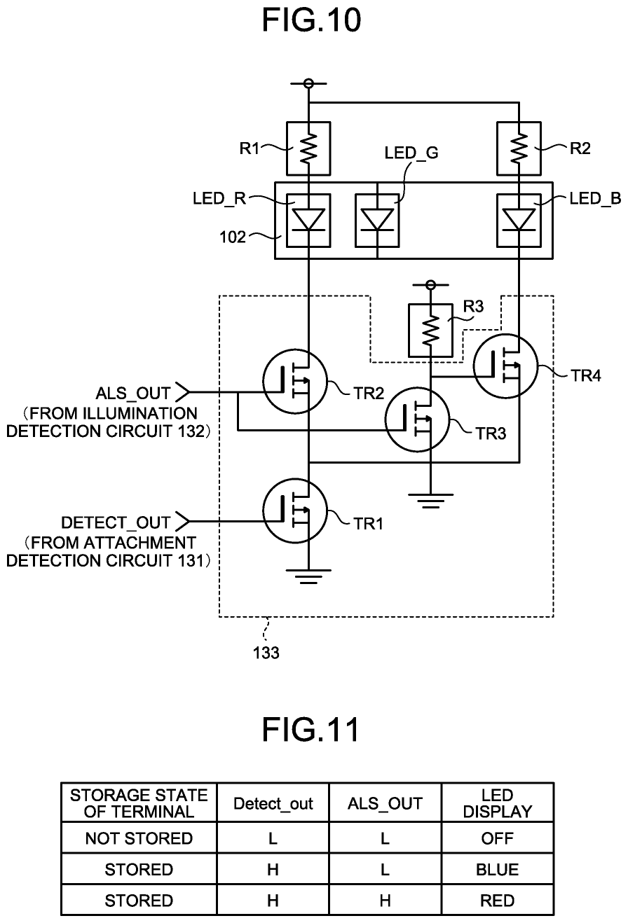

In doing so, the display control circuit 133 illustrated in FIG. 10 controls the indicator light (LED) 102 as illustrated in FIG. 11 so that the flashing pattern of the indicator light 102 corresponds to the flashing pattern of the indicator light 25. FIG. 10 is a diagram illustrating a circuit configuration of the display control circuit 133. FIG. 11 is a diagram illustrating the operation of the display control circuit 133.

As illustrated in FIG. 10, the display control circuit 133 has a plurality of transistors TR1 to TR4. A series connection of transistors TR1 and TR2 is connected to the cathode of a red (R) light-emitting diode LED_R in the indicator light 102, and a power supply potential (for example, direct-current 5V) is connected to the anode of the light-emitting diode LED_R through a resistor R1. A series connection of transistors TR1 and TR4 is connected to the cathode of a blue (B) light-emitting diode LED_B in the indicator light 102, and a power supply potential (for example, direct-current 5V) is connected to the anode of the light-emitting diode LED_B through a resistor R2. A green (G) light-emitting diode LED_G in the indicator light 102 is not used.

An attachment detection signal DETECT_OUT from the attachment detection circuit 131 is supplied to the gate of the transistor TR1, and an illumination detection signal ALS_OUT from the illumination detection circuit 132 is supplied to each of the gate of the transistor TR2 and the gate of the transistor TR3. The transistor TR3 has the drain connected to a power supply potential (for example, direct-current 5V) through a resistor R3 and connected to the gate of the transistor TR4 and has the source connected to a ground potential.

As illustrated in FIG. 11, in a state in which the information terminal 20 is not stored in the housing space 101, both of the attachment detection signal DETECT_OUT and the illumination detection signal ALS_OUT are L level, and the transistors TR1 to TR3 illustrated in FIG. 10 are kept off. Thus, neither the red (R) light-emitting diode LED_R nor the blue (B) light-emitting diode LED_B emits light, and the indicator light 102 is off (LED display=“OFF”).

As illustrated in FIG. 11, in a state in which the information terminal 20 is stored in the housing space 101 but the indicator light 25 is off, the attachment detection signal DETECT_OUT is H level, and the illumination detection signal ALS_OUT is L level. In response, the transistor TR1 illustrated in FIG. 10 is turned on, and the transistors TR2 and TR3 are turned off. Since the transistor TR3 is off, the gate potential of the transistor TR4 is pulled up to the power supply potential through the resistor R3, and the transistor TR4 is turned on. Thus, the red (R) light-emitting diode LED_R is off while the blue (B) light-emitting diode LED_B emits light, and the indicator light 102 turns blue (LED display=“blue”).

As illustrated in FIG. 11, in a state in which the information terminal 20 is stored in the housing space 101 and the indicator light 25 is on, both of the attachment detection signal DETECT_OUT and the illumination detection signal ALS_OUT are H level. In response, all of the transistors TR1 to TR3 illustrated in FIG. 10 are turned on. Since the transistor TR3 is on, the gate potential of the transistor TR4 is pulled down to the ground potential and the transistor TR4 is turned off. Thus, the blue (B) light-emitting diode LED_B is off while the red (R) light-emitting diode LED_R emits light, and the indicator light 102 turns red (LED display=“red”).

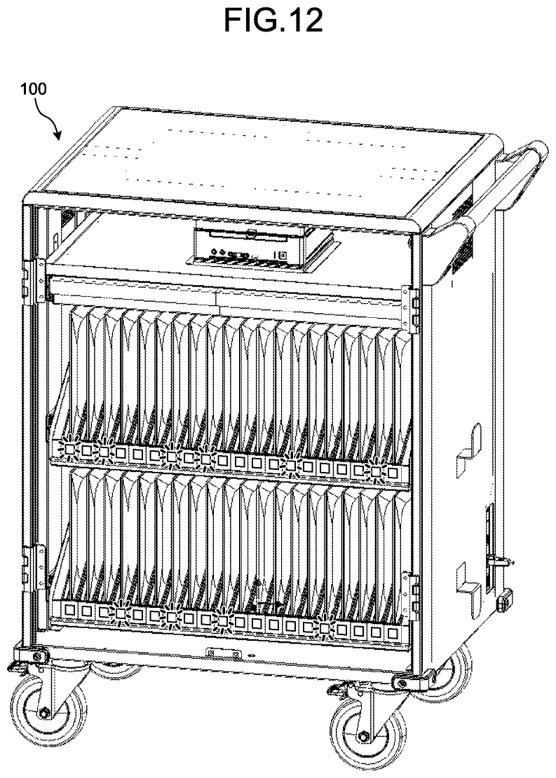

For example, when the indicator light 25 of the information terminal 20 flashes in a flashing pattern of periodically repeating off and on, as illustrated in FIG. 12, the indicator light 102 at the front end of the corresponding housing space 101 flashes in a flashing pattern of periodically repeating blue light and red light. This enables the meeting participants to easily grasp which information terminal 20 of the information terminals 20 stored in the chargeable cabinet 100 is the information terminal for the meeting.

The indicator light 25 of the information terminal 20 not used in the meeting turns on during charging, and the indicator light 25 turns off when charging is completed. The indicator light 102 at the front end of the housing space 101 corresponding to the information terminal 20 not used in the meeting may indicate that charging is in progress by red lighting and indicate that charging is completed by blue lighting.

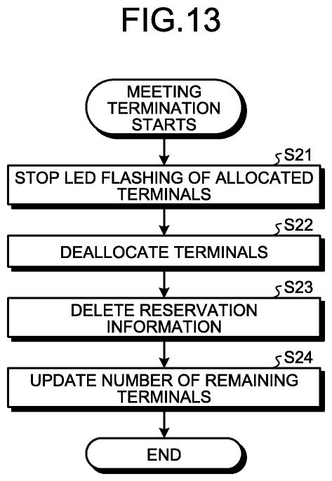

A meeting termination process will now be described with reference to FIG. 13. FIG. 13 is a flowchart illustrating a meeting termination process.

At the timing to terminate the meeting, the meeting organizer's terminal (not illustrated) accesses the server 300 to activate the paperless meeting system 200 on the server 300. Once the paperless meeting system 200 is activated, the meeting organizer's terminal displays a meeting termination screen of the paperless meeting system 200 on the display. When an instruction to terminate the meeting is input to the meeting organizer's terminal, the server 300 transmits the instruction to terminate the selected meeting to the information management device 1, in accordance with the paperless meeting system 200.

When the instruction to terminate the selected meeting is received, the information management device 1 generates flashing stop control information and a meeting material data deletion instruction and transmits the flashing stop control information and the meeting material data deletion instruction to each information terminal selected for the selected meeting. This processing stops the LED flashing in the allocated terminal (S21). More specifically, each information terminal 20 allocated for the selected meeting stops the flashing operation of the indicator light 25 and deletes the meeting material data.

When the flashing operation of the indicator lights 25 is stopped, the server 300 deallocates the information terminals 20 allocated for the selected meeting (S22). More specifically, the server 300 asks the information management device 1 to acquire the terminal management information 14c, in accordance with the paperless meeting system 200. The server 300 overwrites the allocation state with the current meeting number with the allocation state “not in use” in the terminal management information 14c.

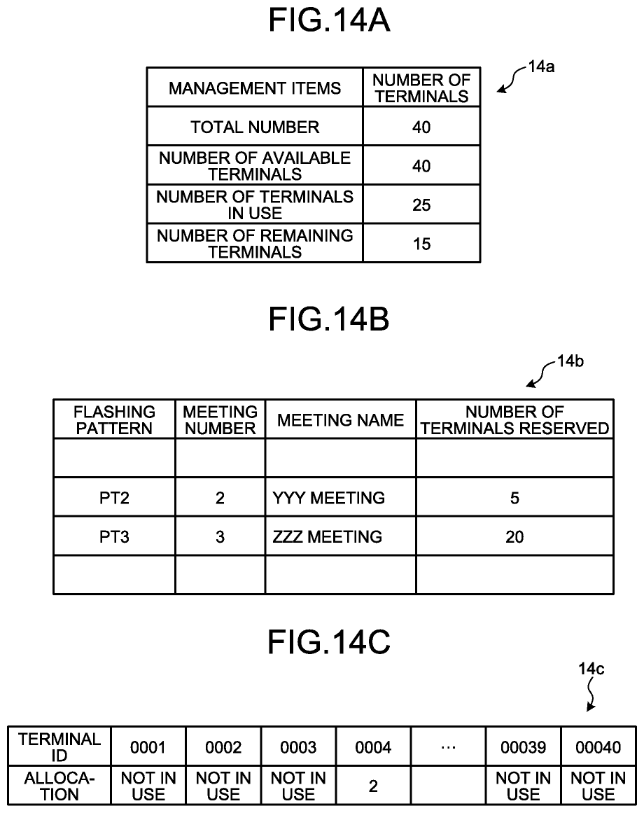

For example, when the meeting with the meeting number “1” illustrated in FIG. 6B is selected, the server 300 overwrites the allocation state with “1” in the terminal management information 14c illustrated in FIG. 8 with “not in use” as illustrated in FIG. 14C. The server 300 transfers the updated terminal management information 14c to the information management device 1. The information management device 1, receiving the updated terminal management information 14c, overwrites the terminal management information 14c on the storage 14.

When the information terminals are deallocated, the server 300 deletes the reservation information for the selected meeting (S23). More specifically, the server 300 asks the information management device 1 to acquire the meeting management information 14b and makes an update to delete the reservation information of the selected meeting from the meeting management information 14b, in accordance with the paperless meeting system 200.

For example, when the meeting with the meeting number “1” illustrated in FIG. 6B is selected, the server 300 deletes a row of the record with the meeting number “1” in the meeting management information 14b and makes an update as illustrated in FIG. 14B.

When the meeting management information 14b is updated, the server 300 transfers the updated meeting management information 14b to the information management device 1. The information management device 1, receiving the updated meeting management information 14b, overwrites the meeting management information 14b on the storage 14.

When the reservation information is deleted, the server 300 updates the number of remaining information terminals (S24). More specifically, the server 300 asks the information management device 1 to acquire the number of terminals management information 14a, updates “number of terminals in use” from “35” to “25” and “number of remaining terminals” from “5” to “15” in the number of terminals management information 14a, and transfers the updated number of terminals management information 14a to the information management device 1, in accordance with the paperless meeting system 200. The information management device 1, receiving the updated number of terminals management information 14a, overwrites the number of terminals management information 14a on the storage 14.

As described above, in the paperless meeting system 200 in the embodiment, the information processing device 1 selectively transmits the meeting material data and the flashing control information to the required number of information terminals 20 in the chargeable cabinet 100, flashes the indicator lights 25 of the required number of information terminals 20, and flashes the indicator lights 102 at the front ends of the housing spaces 101, accordingly. This process enables the meeting participants to easily identify which information terminal 20 in the chargeable cabinet 100 to use.

In the embodiment, in the information processing device 1, the selector 11 selects a plurality of first information terminals to be used for the material data 14d1 from among a plurality of information terminals 20-1 to 20-n, the controller 12 generates first flashing control information to flash the indicator lights of the first information terminals in the first flashing pattern, and the communicator 13 transmits the material data 14d1 and the first flashing control information to each of the selected first information terminals. The selector 11 selects a plurality of second information terminals to be used for the material data 14d2 from among a plurality of information terminals 20-1 to 20-n, the controller 12 generates second flashing control information to flash the indicator lights of the second information terminals in the second flashing pattern, and the communicator 13 transmits the material data 14d2 and the second flashing control information to each of the selected second information terminals. With this configuration, different material data and different flashing control information can be distributed to the required number of different information terminals, for each meeting.

In the embodiment, in the chargeable cabinet 100, a plurality of housing spaces 101 each have the charging terminal 124 corresponding to the to-be-charged terminal 24 in the information terminal 20 and the illumination sensor 125 corresponding to the indicator light 25, the information terminal 20 having the display screen 23, the to-be-charged terminal 24, and the indicator light 25. A plurality of indicator lights 102 correspond to a plurality of housing spaces 101 and are disposed each on the front end of the housing space 101. The controller 130 controls lighting of a plurality of second indicator lights 102, in accordance with the electrical continuity state of the charging terminal 124 and the detection result of the illumination sensor 125 in each of a plurality of housing spaces 101. With this configuration, in accordance with the flashing state of the indicator light 25 of the information terminal 20 stored in the housing space 101, the corresponding indicator light 102 is flashed so as to be easily visible from the outside.

In the embodiment, in the chargeable cabinet 100, for each of a plurality of housing spaces 101, the controller 130 controls lighting of the indicator light 102 in a display state corresponding to the display state of the indicator light 25, in accordance with the detection result of the illumination sensor 125. With this configuration, the indicator light 102 disposed at the front end of the housing space 101 can be flashed so as to correspond to the flashing state of the indicator light 25 of the information terminal 20 stored in the housing space 101.

In the embodiment, in the chargeable cabinet 100, the display state of the indicator light 25 includes a flashing state corresponding to the first flashing pattern indicating that the information terminal 20 is the information terminal to be used for the material data 14d1 or the second flashing pattern indicating that the information terminal 20 is the information terminal to be used for the material data 14d2, and a lighting state indicating whether the information terminal 20 is being charged. With this configuration, the indicator light 102 disposed at the front end of the housing space 101 can be flashed in a flashing state different for each meeting and can be turned on to indicate the charging state.

In the embodiment, the distribution program 8a causes the information processing device 1 to function as the selector 11, the controller 12, and the communicator 13. The selector 11 selects a plurality of first information terminals to be used for the material data 14d1 from among a plurality of information terminals 20-1 to 20-n, the controller 12 generates first flashing control information to flash the indicator lights of the first information terminals in the first flashing pattern, and the communicator 13 transmits the material data 14d1 and the first flashing control information to each of the selected first information terminals. The selector 11 selects a plurality of second information terminals to be used for the material data 14d2 from among a plurality of information terminals 20-1 to 20-n, the controller 12 generates second flashing control information to flash the indicator lights of the second information terminals in the second flashing pattern, and the communicator 13 transmits the material data 14d2 and the second flashing control information to each of the selected second information terminals. With this processing, different material data and different flashing control information can be distributed to the required number of different information terminals, for each meeting.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An information processing device comprising:
a selector that selects a plurality of first information terminals to be used for first material data from among a plurality of information terminals each having a display screen and an indicator light;
a controller that generates first flashing control information to flash the indicator lights of the first information terminals in a first flashing pattern; and
a communicator that transmits the first material data and the first flashing control information to each of the selected first information terminals.

2. The information processing device according to claim 1, wherein
the selector selects a plurality of second information terminals to be used for second material data from among the information terminals,
the controller generates second flashing control information to flash the indicator lights of the second information terminals in a second flashing pattern, and
the communicator transmits the second material data and the second flashing control information to each of the selected second information terminals.

3. A chargeable cabinet comprising:
a plurality of housing spaces each having a charging terminal and an illumination sensor, the charging terminal corresponding to a to-be-charged terminal of an information terminal, the information terminal having a display screen, the to-be-charged terminal, and a first indicator light, the illumination sensor corresponding to the first indicator light;
a plurality of second indicator lights corresponding to the housing spaces, each of the second indicator lights being disposed at a front end of the corresponding housing space; and
a controller that controls lighting of the second indicator lights in accordance with an electrical continuity state of the charging terminal and a detection result of the illumination sensor in each of the housing spaces.

4. The chargeable cabinet according to claim 3, wherein
the controller controls lighting of the second indicator lights in a display state corresponding to a display state of the first indicator light in accordance with the detection result of the illumination sensor.

5. The chargeable cabinet according to claim 4, wherein
the display state of the first indicator light includes
a flashing state corresponding to a first flashing pattern indicating that the information terminal is the information terminal to be used for first material data or a second flashing pattern indicating that the information terminal is the information terminal to be used for second material data, and
a lighting state indicating whether the information terminal is being charged.

6. A non-transitory computer readable medium storing programmed instructions, the instructions, when executed by a computer, causing the computer to perform as:
select a plurality of first information terminals to be used for first material data from among a plurality of information terminals each having a display screen and an indicator light;
generate first flashing control information to flash the indicator lights of the first information terminals in a first flashing pattern; and
transmit first material data and the first flashing control information to each of the selected first information terminals.
